(19) United States
(12) Patent Application Publication
(10) Pub. No.: US 2021/0101262 A1
(43) Pub. Date: Apr. 8, 2021

(54) PIPE WRENCH

(71) Applicant: HANGZHOU GREAT STAR INDUSTRIAL CO., LTD., Hangzhou City (CN)

(72) Inventor: Wei WANG, Hangzhou City (CN)

(21) Appl. No.: 16/971,181

(22) PCT Filed: Feb. 11, 2020
(86) PCT No.: PCT/CN2020/074769

§ 371 Date: Aug. 19, 2020

(30) Foreign Application Priority Data
Dec. 13, 2018 (CN) 201822096650.7

(51) Int. Cl. B25B 13/50

(52) U.S. Cl. CPC B25B 13/5058

(57) ABSTRACT

A pipe wrench comprises a fixed first portion and a movable second portion. The first portion comprises a holding part, a mounting part disposed at one end of the holding part, and a first jaw disposed at a front end of the mounting part. The second portion comprises an adjustment part slidably connected to the first portion, a gripping part disposed at a front end of the adjustment part, and a second jaw disposed on the gripping part. An adjustment element disposed between the first portion and the adjustment part is used to adjust the position of the first portion. The mounting part has is provided therein with a longitudinally penetrating sliding cavity. The adjustment part is adjustably connected in the sliding cavity. An elastic element used to apply an elastic force to the adjustment part is disposed in the sliding cavity. A seal cover blocks the sliding cavity. The first portion is formed by forging. According to the present application, the pipe wrench is light in weight, is convenient to use, is convenient to machine and manufacture, and reduces the manufacturing costs.

### FIELD OF THE INVENTION

The present application relates to the field of manual tools, and in particular to a pipe wrench.

### DESCRIPTION OF THE PRIOR ART

An existing pipe wrench generally comprises a fixed wrench body having a holding part, an L-shaped movable wrench body slidable relative to the fixed wrench body, and an adjustment element used to adjust and fix the position of the movable wrench body relative to the fixed wrench body. A front end of the fixed wrench body is provided with a sliding through hole. The movable wrench body is slidably disposed in the sliding through hole. A fixed jaw is disposed on the fixed wrench body, and a movable jaw opposite the fixed jaw is disposed on the movable wrench body, so as to form a gripping gap between the movable jaw and the fixed jaw. In addition, a certain gap is provided between the movable wrench body and the sliding through hole, and a corresponding spring is disposed in the sliding through hole, so that the movable wrench body can elastically swing by a small angle relative to the fixed wrench body, and an opening between the movable jaw and the fixed jaw forms a bell-mouth-shaped shape with the size decreasing from outside to inside. When a circular pipe needs to be gripped and rotated, the adjustment element is first used to adjust the position of the movable wrench body relative to the fixed wrench body, so that the gripping gap between the movable jaw and the fixed jaw is slightly less than the diameter of the circular pipe, and the circular pipe is then pushed into the gripping gap through the opening between the movable jaw and the fixed jaw. Because there is a certain fitting gap between the movable wrench body and the fixed wrench body, the movable wrench body may form a relatively small swing angle relative to the fixed wrench body. When the circular pipe is pushed into the gripping gap, the movable wrench body overcomes the elastic force of the spring to swing by a relatively small angle. In this case, the opening between the movable jaw and the fixed jaw has a bell-mouth-shaped shape with the size decreasing from outside to inside, so that the circular pipe is conveniently pushed into the gripping gap and the movable jaw and is tightly attached to the fixed jaw. When the holding part is held by a hand to rotate the pipe wrench, the circular pipe may be driven by the friction between the fixed jaw, the movable jaw, and the circular pipe to rotate.

Next, the existing pipe wrench has the following deficiencies: A structure, such as a recess or a protrusion, used to mount or position a member such as a spring further needs to be disposed in the sliding through hole at the front end of the fixed wrench body. An existing machining method using a cutting machine cannot be used to perform secondary machining inside the sliding through hole of the movable wrench body. That is, the structure such as the recess and the protrusion in the sliding through hole cannot be formed through secondary machining. Therefore, an existing fixed wrench body is usually manufactured by using a casting process, so that the structure such as the recess and the protrusion is directly molded inside the sliding through hole. It is known that the casting process has relatively low production efficiency and relatively high production costs, and a molded sand core for casting cannot be reused. In addition, the cast fixed wrench body has relatively low strength. The fixed wrench body needs to bear a relatively heavy load such as a bending moment. Therefore, only the size of the fixed wrench body can be increased to provide the fixed wrench body with sufficient strength. As a result, the overall weight of the pipe wrench increases, the workload of the operator increases, and it demands more effort for the operator to keep using the pipe wrench for a long time.

Therefore, a person skilled in the art strives to develop a pipe wrench that is light in overall weight, is convenient to use, is convenient for machining and grooving, and can reduce the manufacturing costs.

### SUMMARY OF THE INVENTION

In view of the above deficiencies in the prior art, the technical problem to be resolved by the present application is to provide a pipe wrench that is light in overall weight, is convenient to use, is convenient for machining and grooving, and can reduce the manufacturing costs.

To achieve the above objective, the present application provides a pipe wrench, comprising a first portion, a second portion, and an adjustment element;

the first portion comprising:
a holding part;
a mounting part disposed at one end of the holding part; and
a first jaw disposed at one end, away from the holding part, of the mounting part; the second portion comprising:
an adjustment part adjustably connected to the first portion;
a gripping part disposed at one end of the adjustment part; and
a second jaw disposed on the gripping part and located opposite the first jaw; and
the adjustment element being disposed between the first portion and the adjustment part and configured to adjust the distance between the first jaw and the second jaw; wherein
the mounting part has a sliding cavity provided therein penetrating in a lengthwise direction of the first portion, and the adjustment part is adjustably connected in the sliding cavity;
an elastic element is disposed in the sliding cavity, and the elastic element is configured to apply an elastic force to the adjustment part; and
the pipe wrench further comprises a seal cover detachably blocking the sliding cavity.

In some embodiments, optionally, the first portion is integrally formed by forging.

In some embodiments, optionally, an outer side of the mounting part is provided with a notch penetrating inward through the sliding cavity, and the seal cover is fixed on the notch.

In some embodiments, optionally, the notch is provided at an upper side, away from the first portion, of the mounting part, and the sliding cavity is located in the middle of the notch in a thickness direction.

In some embodiments, optionally, the notch is provided at one side, in a thickness direction, of the mounting part.

In some embodiments, optionally, a swing gap allowing the adjustment part to swing is provided between the sliding cavity and the adjustment part.

In some embodiments, optionally, a first groove and a second groove are separately provided at two sides, in a direction perpendicular to the lengthwise direction of the first portion, of the sliding cavity; and wherein a first elastic element is provided in the first groove, and a second elastic element is provided in the second groove.

In some embodiments, optionally, the pipe wrench further comprises a connecting piece, wherein a first edge of the connecting piece bends to form a first stop piece attached to the adjustment part; a second edge, opposite the first edge, on the connecting piece bends to form a second stop piece attached to the adjustment part; the connecting piece, the first stop piece and the second stop piece form a U-shaped groove; and the adjustment part is movably located in the U-shaped groove.

In some embodiments, optionally, the sliding cavity is bell-mouth-shaped, and an opening at one end, away from the holding part, of the sliding cavity is larger than an opening at one end, near the holding part, of the sliding cavity; and one end, near the holding part, of the second stop piece is attached to a side wall of the sliding cavity, and the swing gap is provided between the adjustment part and an upper side wall of one end, near the holding part, of the sliding cavity and between upper and lower side walls of one end, near the first jaw, of the sliding cavity.

In some embodiments, optionally, the first elastic element comprises a column-shaped first compression spring, with one end of the first compression spring abutting the first stop piece, and the other end of the first compression spring abutting a side wall of the first groove; and the second elastic element comprises a column-shaped second compression spring, with one end of the second compression spring abutting the second stop piece, and the other end of the second compression spring abutting a side wall of the second groove.

In some embodiments, optionally, the first stop piece is provided with a first rectangular through hole, the first elastic element comprises a first elastic piece integrally extending outward obliquely from a width edge on one side of the first rectangular through hole, with a suspended end of the first elastic piece abutting the side wall of the first groove; and the second stop piece is provided with a second rectangular through hole, the second elastic element comprises a second elastic piece integrally extending outward obliquely from a width edge on one side of the second rectangular through hole, with a suspended end of the second elastic piece abutting a side wall of the second groove.

In some embodiments, optionally, the first elastic element comprises a column-shaped first compression spring, with one end of the first compression spring abutting the first stop piece, and the other end of the first compression spring abutting a side wall of the first groove; and the second stop piece is provided with a second rectangular through hole, the second elastic element comprises a second elastic piece integrally extending outward obliquely from a width edge on one side of the second rectangular through hole, with a suspended end of the second elastic piece abutting a side wall of the second groove.

In some embodiments, optionally, the first jaw is detachably mounted on the mounting part.

In some embodiments, optionally, a sliding groove is provided at one side, opposite the gripping part, of the mounting part, the first jaw comprises a connecting part, and the connecting part is located in the sliding groove and connected to the mounting part by means of a pin shaft.

In some embodiments, optionally, a third groove is provided at a connection between the holding part and the mounting part, the adjustment element is an adjusting screw sleeve threaded on the adjustment part, and the adjusting screw sleeve is partially located in the third groove.

In some embodiments, optionally, the first portion is provided with a slot hole extending in the lengthwise direction of the first component, at least one obliquely arranged rib plate is disposed in the slot hole, and one of the at least one rib plate is disposed in a position, corresponding to the adjustment element, in the slot hole.

In some embodiments, optionally, an included angle between the rib plate and the lengthwise direction of the first portion is 40 degrees to 70 degrees.

In some embodiments, optionally, the number of the rib plates is 3-4.

In some embodiments, optionally, the slot hole penetrates two side surfaces in a thickness direction of the first portion.

In some embodiments, optionally, the slot hole penetrates at least part of a lower surface of the first portion.

The advantages of the present application are as follows:

1. Restricted by process conditions, a cast fixed wrench body (the first portion) is prone to defects such as air holes, resulting in low overall strength. Therefore, a pipe wrench needs to have a relatively large size to ensure sufficient strength, and consequently has a relatively large weight. In addition, the fixed jaw (the first jaw) and a mounting part usually need to be separately manufactured to provide the fixed jaw (the first jaw) with sufficient hardness and stiffness. In the present application, a notch is provided in an outer side of the mounting part and is used to mount the seal cover, so as to turn the fixed wrench body (the first portion) into a joint structure. In this case, the sliding cavity becomes an open structure. In this way, the fixed wrench body may be manufactured by using a use forging process. Correspondingly, the open sliding cavity may be directly molded by using a forging process, so as to omit a subsequent machining procedure and help reduce manufacturing costs.
2. A forging process can eliminate air hole defects, as-cast loose defects, and the like during metal smelting, thereby optimizing micro-structure, and at the same time a complete metal streamline can be saved, thereby significantly improving mechanical performance such as strength and stiffness. Therefore, the material of the fixed wrench body (the first portion) may be appropriately selected, and a forging process is combined to minimize the size of the fixed wrench body (the first portion), especially the holding part, while the fixed wrench body (the first portion) is provided with sufficient strength, thereby reducing the weight of the pipe wrench. In this way, material consumption can be reduced, and the operation of a user facilitated. Further, the slot hole and the rib plate may be disposed at the holding part to further reduce material consumption.
3. The fixed wrench body (the first portion) with relatively high strength enables the fixed jaw (the first jaw) to be integrally formed by forging with the mounting part, and a thermal treatment process is performed to provide the fixed wrench body with sufficient hardness and stiffness, thereby facilitating assembly and improving the combining strength between the fixed jaw and the mounting part. Further, the open sliding cavity facilitates the assembly of the movable wrench body and the like, and a sliding cavity with a complex shape can be designed according to an actual requirement, thereby making the structural design more convenient.

The concept, specific structure, and resulting technical effect of the present application are further described below in conjunction with the drawings to fully understand the object, features and effects of the present application.

### BRIEF DESCRIPTION OF THE DRAWINGS

FIG. 1 is a front view of a pipe wrench according to the present application;

FIG. 2 is an exploded view of a pipe wrench according to the present application;

FIG. 3 shows a structure when a seal cover blocks an upper side of a mounting part;

FIG. 4 is a structural view of a first implementation of a connecting piece;

FIG. 5 is a structural view of a second implementation of a connecting piece;

FIG. 6 is a structural view of a third implementation of a connecting piece;

FIG. 7 is a schematic view of a swing gap;

FIG. 8 shows that a first jaw is detachably mounted on a first portion;

FIG. 9 shows a first implementation of a first portion being hollowed out;

FIG. 10 shows a second implementation of a first portion being hollowed out;

FIG. 11 is an interface diagram of FIG. 10;

FIG. 12 is a diagram of stress analysis of a pipe wrench; and

FIG. 13 is a schematic view of the bending moment of a cantilever beam in FIG. 12.

In the figures: 1—first portion, 11—holding part, 12—mounting part, 13—first jaw, 14—third groove, 15—seal cover, 16—first slot hole, 17—first rib plate, 18—second rib plate, 19—third rib plate, 101—central line, 102—second slot hole, 103—fourth rib plate, 104—fifth rib plate, 105—sixth rib plate, 106—hanging hole, 107—anti-skid part, 121—sliding cavity, 122—notch, 123—first groove, 124—second groove, 125—swing gap, 126—sliding groove, and 131—connecting part;
2—second portion, 21—adjustment part, 22—gripping part, 23—second jaw, 231—opening, and 3—adjustment element;
40—connecting piece, 41—first stop piece, 411—first elastic piece, 412—first rectangular through hole, 413—first edge, 42—second stop piece, 421—second elastic piece, 422—second rectangular through hole, and 423—second edge; and
50—first compression spring, 51—second compression spring, and 60—pin shaft.

### DETAILED DESCRIPTION OF THE PREFERRED EMBODIMENTS

Preferred embodiments of the present application are described below with reference to the drawings of the specification to make the technical contents clearer and easier to understand. The present application can be embodied in various forms of embodiments, and the scope of protection of the present application is not limited to the embodiments mentioned herein.

In the drawings, the same reference numeral indicates elements having the same structure, and similar reference numerals indicate assemblies having similar structures or functions throughout. The size and thickness of each assembly shown in the figures are shown arbitrarily, and the present application does not define the size and thickness of each assembly. In order to make the illustration clearer, the thickness of the element in some places of the figures is appropriately exaggerated.

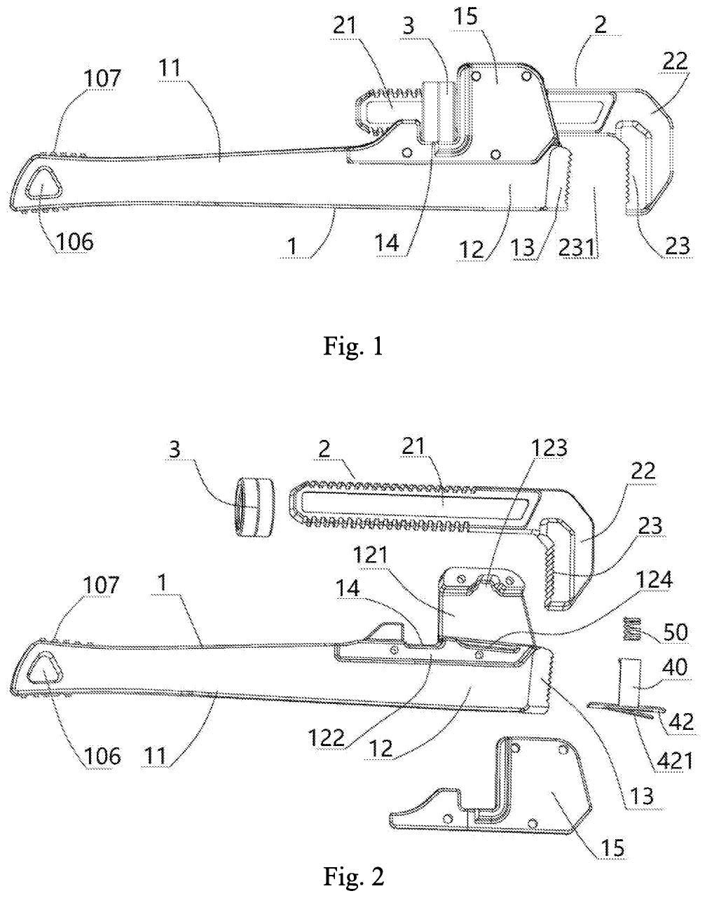

As shown in FIGS. 1 and 2, a preferred embodiment of the present application provides a pipe wrench, comprising a first portion 1 and a second portion 2. The first portion 1 is a fixed wrench body. The second portion 2 is an L-shaped movable wrench body slidable relative to the first portion 1. The first portion 1 comprises a rod-shaped holding part 11, a mounting part 12 disposed at one end of the holding part 11, and a first jaw 13 disposed at one end, away from the holding part 11, of the mounting part 12. A gripping surface of the first jaw 13 has a serrated form. The second portion 2 is L-shaped and comprises an adjustment part 21 and a gripping part 22. The adjustment part 21 is adjustably connected to the first portion 1. The gripping part 22 is disposed at one end, away from the holding part 11, of the adjustment part 21 and bends downward. A second jaw 23 is disposed on the gripping part 22. A gripping surface of the second jaw 23 has a serrated form, and is disposed opposite the first jaw 13, so that an opening 231 used to grip a pipe is formed between the first jaw 13 and the second jaw 23.

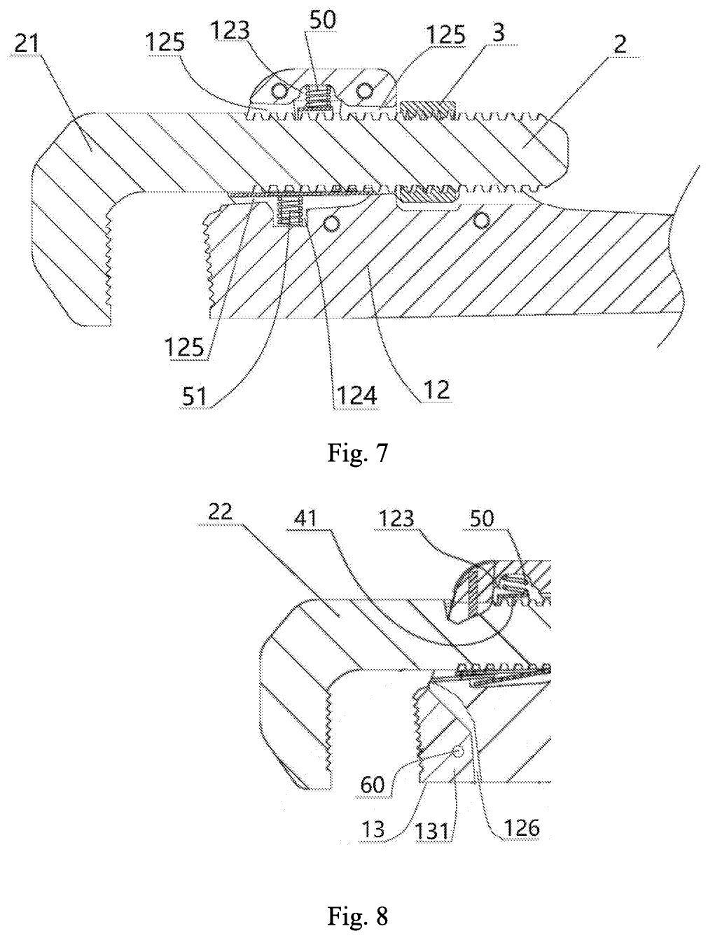

The mounting part 12 protrudes in a direction perpendicular to a lengthwise direction of the first portion 1 to form a protruding part. The protruding part is provided with a penetrating sliding cavity 121 in the lengthwise direction of the first portion 1. The adjustment part 21 is slidably connected in the sliding cavity 121, and a swing gap 125 (as shown in FIG. 7) allowing the adjustment part 21 to swing is provided between the adjustment part 21 and the sliding cavity 121. An adjustment element 3 is disposed between the first portion 1 and the adjustment part 21, and is used to adjust the position of the second portion 2, so as to adjust the size of the gap of the opening 231, to adapt to pipes with different pipe diameters. A third groove 14 is provided at a connection between the holding part 11 and the protruding part of the mounting part 12 and is used to position the adjustment element 3. The adjustment element 3 is an adjusting screw sleeve threaded on the adjustment part 21. A lower part of the adjusting screw sleeve is located in the third groove 14, so that the adjusting screw sleeve is positioned in an axial direction of the adjustment part 21. When the adjusting screw sleeve is rotated in different directions, the adjustment part 21 may be driven to move back and forth in the lengthwise direction of the first portion 1, so as to adjust the size of the gap of the opening 231.

The sliding cavity 121 is an open structure. That is, in addition to two openings for the adjustment part 21 to pass through, the sliding cavity 121 further has an opening. During mounting, the adjustment part 21 is placed in the sliding cavity 121, and a seal cover 15 is then used to cover the sliding cavity 121, so that the first portion 1 is turned into a joint structure. The first portion 1 is manufactured by using a forging process. The open sliding cavity 121 may be directly molded by using a forging process. Compared with a conventional casting process, a subsequent machining procedure is omitted, thereby helping reduce manufacturing costs. In addition, a forging process can eliminate air hole defects, as-cast loose defects, and the like during metal smelting, thereby optimizing micro-structure, and at the same time a complete metal streamline is saved, thereby significantly improving mechanical performance such as strength and stiffness of the first portion 1. Therefore, the material of the first portion 1 may be appropriately selected, and a forging process is combined to minimize the size of the first portion 1, especially the holding part 11, while the first portion 1 is provided with sufficient strength, thereby reducing the weight.

To facilitate both the forging of the first portion 1 and the assembly of the pipe wrench, a concave mounting notch 122 is provided in an outer side of the mounting part 12. The notch 122 extends into the mounting part 12 to penetrate the sliding cavity 121. A bottom surface of the notch 122 forms a joint interface mounted between the notch 122 and the sliding cavity 121. The seal cover 15 is mounted on the joint interface, so as to cover the sliding cavity 121, so that the mounting part 12 forms the joint structure.

In a preferred implementation, as shown in FIG. 2, the notch 122 is provided in one side of the mounting part 12. The side of the mounting part 12 herein is either side of the mounting part 12 in a thickness direction thereof. The joint interface and a side wall of the sliding cavity 121 are coplanar, so as to maximize an opening of the open sliding cavity 121 in a lateral direction, so that it is convenient to directly mold a concave structure such as a sliding cavity through die forging to facilitate subsequent assembly and the overall flexural strength of the pipe wrench is not greatly affected. In this case, the seal cover 15 is fixed on the joint interface through four screws disposed near edges. That is, in this case, the sliding cavity 121 is completely disposed on the mounting part 12. The seal cover 15 is only used to cover the opening on one side surface of the sliding cavity 121.

During the working of the pipe wrench, the first portion 1 mainly bears a bending moment in a vertical direction. As can be seen from the theory of mechanics of materials, the width of the mounting part 12 in a direction perpendicular to the lengthwise direction of the first portion 1 mainly helps increase the flexural strength of the pipe wrench. The size of the first portion 1 in the lengthwise direction does not greatly affect the flexural strength of the pipe wrench. Therefore, by means of this implementation, the width of the mounting part 12 can be minimized.

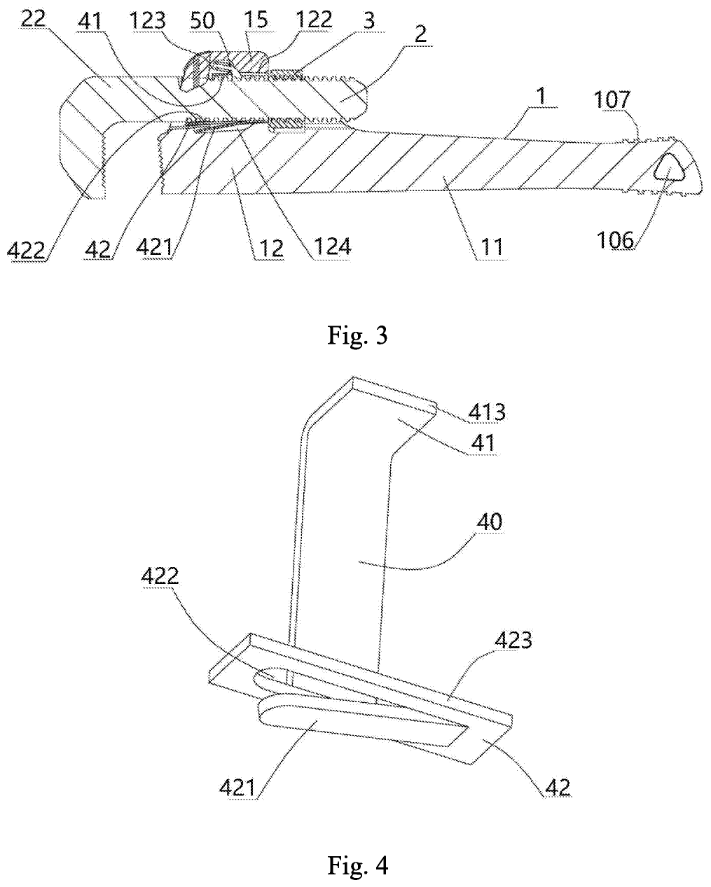

In another preferred implementation, as shown in FIG. 3, the notch 122 may be provided in an upper side, away from the first portion 1, of the mounting part 12. The joint interface and an upper side wall of the sliding cavity 121 are coplanar. The seal cover 15 is fixed on the joint interface by four screws disposed at corners, so as to enable the mounting part 12 and the seal cover 15 to form a vertical joint structure, thereby minimizing the thickness of the mounting part 12. That is, in this case, the sliding cavity 121 is completely disposed on the mounting part 12. The seal cover 15 blocks the opening in an upper side of the sliding cavity 121. In addition, the sliding cavity 121 may be located in the middle of the notch 122, so that the sliding cavity 121 has basically consistent wall thicknesses on two sides of the mounting part 12 in a thickness direction. Therefore, it can be ensured that the mounting part 12 has uniform and consistent strength.

To enable the adjustment part 21 to be elastically positioned in the sliding cavity and form the swing gap 125 between the adjustment part 21 and the sliding cavity 121 to make it convenient for the adjustment part 21 to swing back and forth in the sliding cavity 121 in the direction perpendicular to the lengthwise direction of the first portion 1. Grooves may be separately provided in two sides, in the direction perpendicular to the lengthwise direction of the first portion 1, of the sliding cavity 121. That is, a first groove 123 is provided in an upper side in the direction perpendicular to the lengthwise direction of the first portion 1, and a second groove 124 is provided in the lower side in the direction perpendicular to the lengthwise direction of the first portion 1. An elastic element elastically abutting the adjustment part 21 is separately disposed in the first groove 123 and the second groove 124. In this way, each of the elastic elements on both sides in the vertical direction applies a pretightening elastic force to the adjustment part 21 to elastically position the adjustment part 21 in the sliding cavity 121. When a pipe is clamped in the opening 231 between the first jaw 13 and the second jaw 23 of the pipe wrench, the pipe applies upward torque to the second portion 2. The second portion 2 swings upward by an angle. Correspondingly, the gap of the opening 231 is slightly expanded. In this case, the elastic elements enable the first jaw 13 and the second jaw 23 to apply pretightening gripping forces to the pipe, so as to apply sufficient friction between the first jaw 13, the second jaw 23, and the pipe. When a force is applied to rotate the holding part 11 to rotate the pipe, a front end of the first portion 1 swings downward slightly. Correspondingly, in this case, the opening 231 is shrunk slightly to prevent the adjustment part 21 from being stuck in the sliding cavity 121, to further enable the first jaw 13 and the second jaw 23 to grip the pipe tightly.

In an implementation, when the seal cover 15 is disposed on a side wall of the mounting part 12 in a thickness direction, as shown in FIG. 2, the first groove 123 and the second groove 124 are disposed on upper and lower side walls of the sliding cavity 121 in the direction perpendicular to the lengthwise direction of the first portion 1. The first groove 123 and the second groove 124 may be integrally molded during die forging of the sliding cavity 121.

In another implementation, when the seal cover 15 is disposed on the upper side, away from the first portion 1, of the mounting part 12, as shown in FIG. 7, the second groove 124 may be disposed in a lower side (that is, one side facing the seal cover 15) of the sliding cavity 121. The second groove 124 may be integrally molded during die forging of the sliding cavity 121. Moreover, the first groove 123 located on an upper side of the adjustment part 21 is disposed on an inner side, facing the sliding cavity 121, of the seal cover 15. Elastic elements abutting the adjustment part 21 are then separately disposed in the first groove 123 and the second groove 124. In this case, the vertical joint structure between the mounting part 12 and the seal cover 15 facilitates pretightening and mounting of additional elements, thereby avoiding the additional elements from being ejected outward during assembly.

As shown in FIGS. 2, 3, 4, 5, 6 and 7, a connecting piece 40 attached to the adjustment part 21 is disposed on one side, in a thickness direction of the first portion 1, of the adjustment part 21. A first edge 413 of the connecting piece 40 bends by 90 degrees to form a first stop piece 41 attached to the adjustment part 21, and a second edge 423 opposite the first edge 413 bends by 90 degrees to form a second stop piece 42 attached to the adjustment part 21. The connecting piece 40, the first stop piece 41, and the second stop piece 42 form a U-shaped structure. The adjustment part 21 is movably located in the U-shaped groove, so that it can be ensured that the adjustment part 21 moves freely in the sliding cavity 121.

In a preferred implementation, as shown in FIG. 6, both the first stop piece 41 and the second stop piece 42 are solid structures. As shown in FIG. 7, the elastic element disposed in the first groove 123 is a column-shaped first compression spring 50. One end of the first compression spring 50 abuts the first stop piece 41, and the other end abuts a side wall of the first groove 123. The elastic element disposed in the second groove 124 is a column-shaped second compression spring 51. One end of the second compression spring 51 abuts the second stop piece 42, and the other end abuts a side wall of the second groove 124. In this case, during the movement of the adjustment part 21, interference can be avoided between the adjustment part and the compression spring. The column-shaped compression spring has a simple structure and low costs. With the use of the column-shaped compression spring, manufacturing costs are reduced and the structure is simplified.

In another preferred implementation, as shown in FIGS. 2, 3 and 4, the first stop piece 41 is a solid structure. The elastic element disposed in the first groove 123 is the column-shaped first compression spring 50. A strip-shaped second rectangular through hole 422 extending in the lengthwise direction of the first portion 1 is provided in the second stop piece 42. The elastic element disposed in the second groove 124 comprises a second elastic piece 421 integrally extending downward obliquely from a width edge on one side of the second rectangular through hole 422.

A suspended end of an elastic piece 421 abuts a side wall of the second groove 124.

During the use of the pipe wrench, an angle by which the second portion 2 swings upward is much greater than an angle by which the second portion swings downward. Therefore, the elastic element on two sides in this implementation are separately formed by the first compression spring 50 and the second elastic piece 421. In an aspect, the compression spring on the upper side has a relatively large amount of deformation, the second portion 2 may have a relatively large amount of upward swing. In another aspect, the second elastic piece 421 on the lower side may minimize the size of the second groove 124, to prevent the strength of the mounting part 12 from being adversely affected.

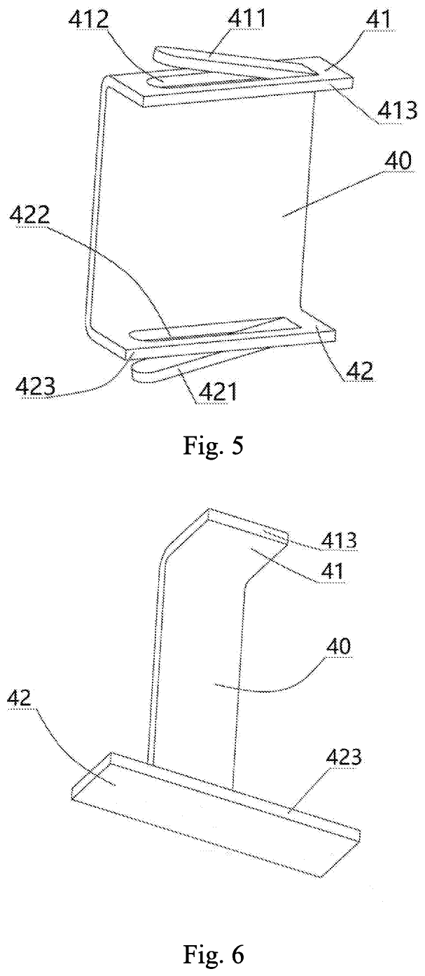

In still another preferred implementation, as shown in FIG. 5, a strip-shaped first rectangular through hole 412 extending in the lengthwise direction of the first portion 1 is provided in the first stop piece 41. The elastic element disposed in the first groove 123 comprises a first elastic piece 411 integrally extending downward obliquely from a width edge on one side of the first rectangular through hole 412. A suspended end of the first elastic piece 411 abuts a side wall of the first groove 123. In addition, a strip-shaped second rectangular through hole 422 extending in the lengthwise direction of the first portion 1 is provided in the second stop piece 42. The elastic element disposed in the second groove 124 comprises a second elastic piece 421 integrally extending downward obliquely from a width edge on one side of the second rectangular through hole 422. A suspended end of the elastic piece 421 abuts a side wall of the second groove 124.

Compared with the column-shaped first compression spring 50 and second compression spring 51, the elastic element formed by an elastic piece can minimize the sizes of the first groove 123 and/or the second groove 124, thereby reducing the size of the mounting part 12 in a direction perpendicular to the first portion 1. The elastic piece may be integrally manufactured with the connecting piece 40 and the stop pieces 41 and 42 by using a stamping molding process, so as to simplify a manufacturing procedure and assembly.

To make it convenient for the adjustment part 21 to swing in the sliding cavity 121, the sliding cavity 121 is bell-mouth-shaped, and an opening at one end, away from the holding part 11, of the sliding cavity 121 is larger than an opening at one end, near the holding part 11, of the sliding cavity 121. As shown in FIG. 7, the longitudinal positions of the elastic elements in the first groove 123 and the second groove 124 and the magnitude of the pretightening elastic force are appropriately controlled to enable one end, near the holding part 11, of the second stop piece 42 to be attached to a side wall of the sliding cavity 121, so as to form the swing gap 125 on the upper and lower sides at the ends, away from the holding part 11, of the adjustment part 21 and the sliding cavity 121 and form the swing gap 125 in an upper side at the end, near the holding part 11, of the sliding cavity 121.

By means of a member formed by the connecting piece 40, the first stop piece 41, and the second stop piece 42, when the adjustment element 3 is rotated to enable the adjustment part 21 to move longitudinally, friction or interference can be prevented between the adjustment part 21 and two side walls of the sliding cavity 121 in the direction perpendicular to the lengthwise direction of the first portion 1. In addition, an attachment point between the end, near the holding part 11, of the second stop piece 42 and the sliding cavity 121 forms a swing fulcrum during vertical swing of the adjustment part 21, to enable the adjustment part 21 to swing vertically around the swing fulcrum in the bell-mouth-shaped sliding cavity 121.

In all the foregoing implementations, the holding part 11, the mounting part 12, and the first jaw 13 of the first portion 1 may all be integrally manufactured through forging. In another implementation, the first jaw 13 is detachably fixed on the mounting part 12. As shown in FIG. 8, a sliding groove 126 is provided in a position, in which the first jaw 13 is mounted, on the mounting part 12. The first jaw 13 comprises a connecting part 131. The connecting part 131 is connected in the sliding groove 126, and is fixedly connected to the mounting part 12 by a pin shaft 60. When the first jaw 13 needs to have higher mechanical performance, in this implementation, the first jaw 13 and the body part of the first portion 1 may be separately manufactured and then detachably mounted on the mounting part 12.

In all the foregoing implementations, the body part of the first portion 1 in the lengthwise direction may be completely a solid structure. While the structural strength is ensured, to further reduce the weight of the pipe wrench and facilitate use by a user, a hollowed-out design may be used on the first portion 1.

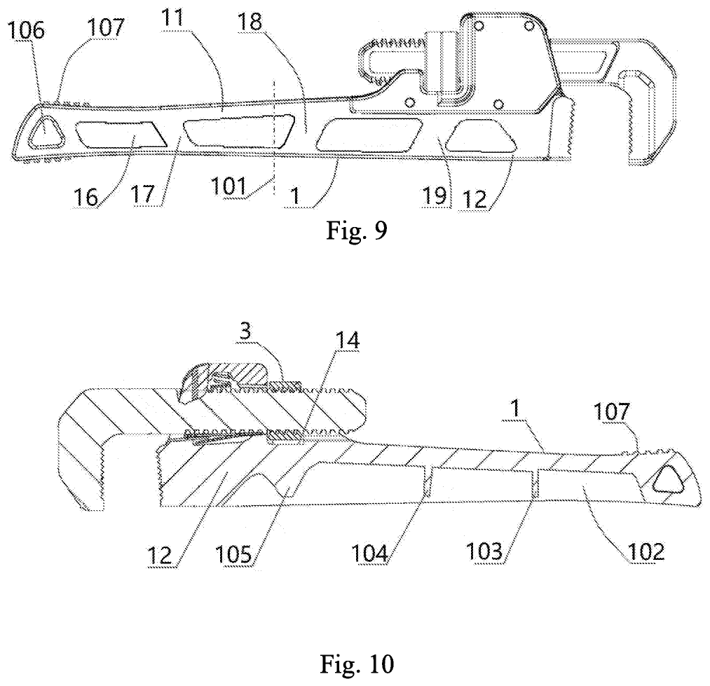

In a preferred implementation, as shown in FIG. 9, a first slot hole 16 is provided in the lengthwise direction in the holding part 11 and the mounting part 12 of the first portion 1. The first slot hole 16 penetrates two side surfaces of the first portion 1 in a thickness direction. An obliquely arranged rib plate is disposed in the first slot hole 16. In this implementation, the number of the rib plates is three. The three rib plates are sequentially arranged in a lengthwise direction of the first slot hole 16, and are a first rib plate 17, a second rib plate 18, and a third rib plate 19. The rib plates located on two sides of a central line 101 of the first portion 1 tilt in opposite directions. The third rib plate 19 is disposed in a position, corresponding to the adjustment element 3, in the first slot hole 16. An included angle between each rib plate and the lengthwise direction of the first portion 1 is 40 degrees to 70 degrees. The thickness of each rib plate is 13 millimeters to 15 millimeters.

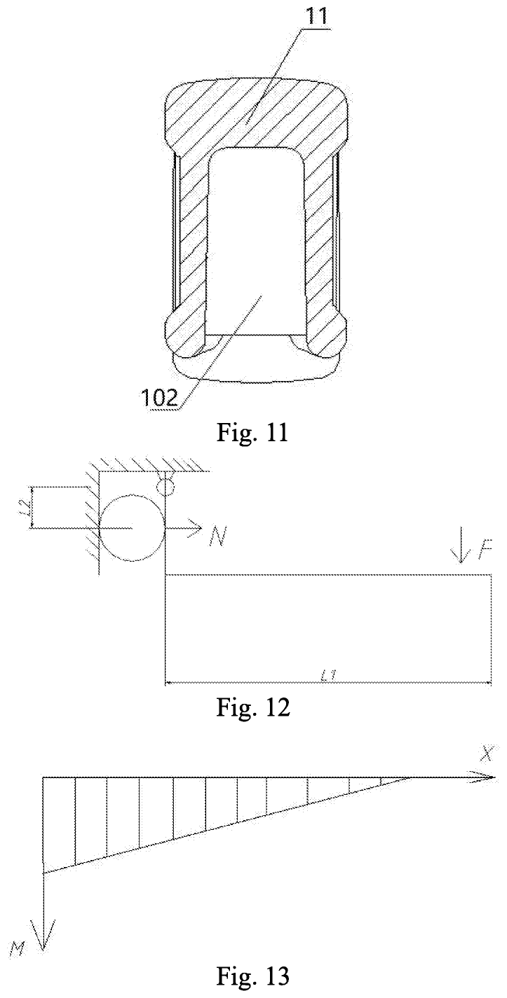

In another preferred implementation, as shown in FIGS. 10 and 11, a difference between the implementation and the foregoing implementations lies in that in place of the first slot hole 16, a second slot hole 102 is provided in the lengthwise direction of the first portion 1. The second slot hole 102 penetrates at least partial lower surface of the first portion 1. The second slot hole 102 starts to extend to the mounting part 12 from the holding part 11. A rib plate is disposed in the second slot hole 102. In this implementation, the number of the rib plates is three. The three rib plates are sequentially disposed in a lengthwise direction of the second slot hole 102, and are a fourth rib plate 103, a fifth rib plate 104, and a sixth rib plate 105. The sixth rib plate 105 is disposed in a position, corresponding to the adjustment element 3, of the second slot hole 102.

In the foregoing two implementations, the number of the rib plates is not limited to three and may be set according to an actual requirement. More or fewer rib plates may be disposed. Stress analysis in a working state of the present application is provided below. The pipe wrench may be simplified as a diagram in FIG. 12. For the first portion 1, the pipe wrench may be simplified as a cantilever beam for analysis. When the pipe wrench is used to wrench a pipe, a user applies a force F1 in a direction perpendicular to an axial direction of the first portion 1 at a rear end (that is, one end away from the second portion 2) of the first portion 1. The pipe applies a force N in a direction perpendicular to the surface to the surface of the second jaw 23. A distance between the force F1 and a moment center is L1, and a distance between the force N and the moment center is L2. According to the theory of mechanics, it may be obtained that F1×L1=N×L2.

In FIG. 13, X represents a distance between a bending moment point on the first portion 1 and the moment center, and M represents a bending moment value at the point. It can be learned according to FIG. 13 that, during the use of the pipe wrench, a bending moment is larger in a position closer to the moment center of the front end (that is, one end near the first jaw 13) of the first portion 1. Therefore, the internal stress is larger in the position. A bending moment is smaller in a position near the rear end of the first portion 1. Therefore, the internal stress is smaller in the position. The bending moment gradually decreases from the front end to the rear end of the first portion 1. At a part corresponding to the adjustment element 3 of the pipe wrench, because the part is close to the front end of the first portion 1 and is provided with the third groove 14 that is concave downward, during actual use, the part is the earliest to reach an area of a stress limit. Therefore, in the foregoing implementation, after hollowed-out treatment is performed on the first portion 1, a rib plate is disposed in the area to satisfy a strength requirement of the first portion 1.

To further facilitate use, a hanging hole 106 may further be provided at the rear end of the first portion 1. An anti-skid part 107 may further be disposed on upper and lower surfaces of the rear end of the first portion 1. The anti-skid part 107 comprises several strip-shaped convex parts. The convex parts are separately disposed on the upper and lower surfaces of the rear end of the first portion 1 and are sequentially disposed in the lengthwise direction of the first portion 1.

The specific preferred embodiments of the present application are described in detail as above. It should be appreciated that a person of ordinary skill in the art would be able to make modifications and variations in accordance with the concept of the present application without involving any inventive effort. Therefore, any technical solution that can be obtained by a person skilled in the art by means of logical analysis, reasoning or limited trials on the basis of the prior art and according to the concept of the present application should be comprised within the scope of protection of the claims.

1. A pipe wrench, comprising a first portion, a second portion and an adjustment element;
the first portion comprising:
a holding part;
a mounting part disposed at one end of the holding part; and
a first jaw disposed at one end, away from the holding part, of the mounting part;
the second portion comprising:
an adjustment part adjustably connected to the first portion;
a gripping part disposed at one end of the adjustment part; and
a second jaw disposed on the gripping part and located opposite the first jaw; and
the adjustment element being disposed between the first portion and the adjustment part and configured to adjust the distance between the first jaw and the second jaw;
wherein
the mounting part has a sliding cavity provided therein penetrating in a lengthwise direction of the first portion, and the adjustment part is adjustably connected in the sliding cavity;
an elastic element is disposed in the sliding cavity, and the elastic element is configured to apply an elastic force to the adjustment part; and
the pipe wrench further comprises a seal cover detachably blocking the sliding cavity.

2. The pipe wrench of claim 1, wherein the first portion is integrally formed by forging.

3. The pipe wrench of claim 1, wherein an outer side of the mounting part is provided with a notch penetrating inward through the sliding cavity, and the seal cover is fixed on the notch.

4. The pipe wrench of claim 3, wherein the notch is provided at an upper side, away from the first portion, of the mounting part, and the sliding cavity is located in the middle of the notch in a thickness direction.

5. The pipe wrench of claim 3, wherein the notch is provided at one side, in a thickness direction, of the mounting part.

6. The pipe wrench of claim 1, wherein a swing gap allowing the adjustment part to swing is provided between the sliding cavity and the adjustment part.

7. The pipe wrench of claim 6, wherein a first groove and a second groove are separately provided at two sides, in a direction perpendicular to the lengthwise direction of the first portion, of the sliding cavity; and
wherein a first elastic element is provided in the first groove, and a second elastic element is provided in the second groove.

8. The pipe wrench of claim 7, further comprising a connecting piece, wherein a first edge of the connecting piece bends to form a first stop piece attached to the adjustment part; a second edge, opposite the first edge, on the connecting piece bends to form a second stop piece attached to the adjustment part; the connecting piece, the first stop piece and the second stop piece form a U-shaped groove; and the adjustment part is movably located in the U-shaped groove.

9. The pipe wrench of claim 8, wherein the sliding cavity is bell-mouth-shaped, and an opening at one end, away from the holding part, of the sliding cavity is larger than an opening at one end, near the holding part, of the sliding cavity; and one end, near the holding part, of the second stop piece is attached to a side wall of the sliding cavity, and the swing gap is provided between the adjustment part and an upper side wall of one end, near the holding part, of the sliding cavity and between upper and lower side walls of one end, near the first jaw, of the sliding cavity.

10. The pipe wrench of claim 8, wherein the first elastic element comprises a column-shaped first compression spring, with one end of the first compression spring abutting the first stop piece, and the other end of the first compression spring abutting a side wall of the first groove; and the second elastic element comprises a column-shaped second compression spring, with one end of the second compression spring abutting the second stop piece, and the other end of the second compression spring abutting a side wall of the second groove.

11. The pipe wrench of claim 8, wherein the first stop piece is provided with a first rectangular through hole, the first elastic element comprises a first elastic piece integrally extending outward obliquely from a width edge on one side of the first rectangular through hole, with a suspended end of the first elastic piece abutting the side wall of the first groove; and the second stop piece is provided with a second rectangular through hole, the second elastic element comprises a second elastic piece integrally extending outward obliquely from a width edge on one side of the second rectangular through hole, with a suspended end of the second elastic piece abutting a side wall of the second groove.

12. The pipe wrench of claim 8, wherein the first elastic element comprises a column-shaped first compression spring, with one end of the first compression spring abutting the first stop piece, and the other end of the first compression spring abutting a side wall of the first groove; and the second stop piece is provided with a second rectangular through hole, the second elastic element comprises a second elastic piece integrally extending outward obliquely from a width edge on one side of the second rectangular through hole, with a suspended end of the second elastic piece abutting a side wall of the second groove.

13. The pipe wrench of claim 1, wherein the first jaw is detachably mounted on the mounting part.

14. The pipe wrench of claim 13, wherein a sliding groove is provided at one side, opposite the gripping part, of the mounting part, the first jaw comprises a connecting part, and the connecting part is located in the sliding groove and connected to the mounting part by means of a pin shaft.

15. The pipe wrench of claim 1, wherein a third groove is provided at a connection between the holding part and the mounting part, the adjustment element is an adjusting screw sleeve threaded on the adjustment part, and the adjusting screw sleeve is partially located in the third groove.

16. The pipe wrench of claim 1, wherein the first portion is provided with a slot hole extending in the lengthwise direction of the first component, at least one obliquely arranged rib plate is disposed in the slot hole, and one of the at least one rib plate is disposed in a position, corresponding to the adjustment element, in the slot hole.

17. The pipe wrench of claim 16, wherein an included angle between the rib plate and the lengthwise direction of the first portion is 40 degrees to 70 degrees.

18. The pipe wrench of claim 16, wherein the number of the rib plates is 3-4.

19. The pipe wrench of claim 16, wherein the slot hole penetrates two side surfaces in a thickness direction of the first portion.

20. The pipe wrench of claim 16, wherein the slot hole penetrates at least part of a lower surface of the first portion.
